(19) United States
(12) Patent Application Publication
(10) Pub. No.: US 2008/0255879 A1
(43) Pub. Date: Oct. 16, 2008

(54) Colo-rectal cancer screening system and method

(76) Inventors: Mark Baumel, Kennett Square, PA (US); Edward C. White, Chadds Ford, PA (US)

Correspondence Address: Ober, Kaler, Grimes & Shriver;Royal W. Craig, 120 East Baltimore Street, Baltimore, MA, 21202-1643, US

(21) Appl. No.: 12/082,716

(22) Filed: Apr. 14, 2008

Related U.S. Application Data
(60) Provisional application No. 60/923,401, filed on Apr. 13, 2007.

(51) Int. Cl. G06Q 50/00

(52) U.S. Cl. 705/2

(57) ABSTRACT

The present invention is a colorectal cancer screening system that may be contractually deployed as a managed operation, either licensed or sold to community GIs or other endoscopists who also own endoscopy centers. The system includes an imaging center co-located with an existing or new endoscopy center, and a workflow there between that integrates the two modalities along with radiology services. The imaging center serves as a computed tomography colonography (CTC) or magnetic resonance imaging (MRI) screen and patient referral source to the endoscopy center. The defined workflow is a process for same-day patient flow generally comprising the steps of the imaging center submitting images for interpretation immediately after image acquisition, reporting the results to the patient, and when problems are detected, immediately directing and admitting the patient to the endoscopy center for same-day OC under an exclusive provider agreement. The foregoing system and workflow ensures optimal and customized use of technology for each patient, that is minimally invasive to patients, improves patient acceptance and satisfaction, avoids the need for an uncomfortable and inconvenient second colon prep, reduces overall healthcare costs, and results in higher community colorectal cancer screening rates.

### CROSS-REFERENCE TO RELATED APPLICATION(S)

The present application derives priority from U.S. provisional application Ser. No. 60/923,401 filed 13 Apr. 2007.

### BACKGROUND OF THE INVENTION

1. Field of the Invention

The present invention relates to a colorectal cancer screening process, and more particularly to a colorectal cancer screening system and method that integrates an imaging center with an endoscopy center and radiology services. The imaging center provides computed tomography colonography (CTC) or magnetic resonance imaging (MRI) images and colon cancer prescreen and patient referral source to the endoscopy center, along with the defined implementing process for same-day, same-prep patient flow ensuring the optimal and customized use of technology for each patient.

2. Description of the Background

According to the American Cancer Society, each year 150,000 Americans are diagnosed with colorectal cancer, and 57,000 die annually from this cancer. Everyone is at risk for colon cancer. For most people, the risk begins to accelerate at age 50 at which time they should consider having their initial colon cancer screening. Individuals older than 50 years old and at baseline risk should be screened for polyps every 5 to 10 years. Despite the high number of individuals who die from this malignant disease, only half of all Americans over the age of 50 are screened for colorectal cancer and only one-third of Americans over the age of 50 have been screened with the preferred “whole bowel” examination. There are a number of reasons for this low screening rate, namely patients lack awareness of the need for screening, or patients want to avoid the discomfort involved in preparation for the screening and/or the invasiveness of the screening. The most common method of screening for colon cancer is optical colonoscopy (OC), which has been employed on a widespread basis for the last ten years. OC involves a physician endoscopist inserting a long flexible scope (flexible tube with a fiber optic camera) into the patient's rectum and passing it all the way to the distal end of the large colon in order to view the entire large colon for abnormalities, most commonly polyps. Polyps are growths that arise from the inner lining of the intestine, and some polyps may grow and turn into cancer. The goal of screening with OC is to find and remove these growths in their early stages and avoid their potential conversion to colon cancer. In addition to finding polyps, OC gives physician endoscopists the option to therapeutically intervene, by biopsying and resecting the polyp(s), while a pathological examination of the resected tissue determines if it is malignant.

The patient is required to perform a colon preparation (prep) prior to the OC, which involves limiting food intake to clear liquids on the day before the procedure and then ingesting a set of pills or a cathartic liquid the night before the procedure in order to cleanse the bowel so that the physician endoscopist can clearly see any polyps that might be present when performing the OC. Some common preparations are the Fleet Prep Kit 1 (phospho-soda and Bisacodyl) and NuLytely® or Go-Lytely® (Polyethylene glycol electrolyte solutions).

When not sedated, the OC procedure itself can be uncomfortable for patients and most require sedation or anesthesia. However, patients who receive sedation or anesthesia require the additional inconvenience of needing to be driven home by another individual following the OC, and are advised not to perform other critical activities for the remainder of the day following the OC. A further disadvantage of OC and/or anesthesia involves uncommon complications including hemorrhage, perforation of the colon, breathing/airway emergencies, and even death. Additionally, OC can occasionally miss a polyp hidden behind a colon fold, and therefore is not a perfect test. However, it is highly sensitive to detecting abnormalities (˜90%) and is the current “gold standard” for detecting colon polyps. Health insurers currently reimburse for screening OC.

Computed tomography colonography (CTC) (also known as “virtual colonoscopy”), a noninvasive method of imaging the colon using helical CT, was introduced in 1994 but perfected only in the last few years. With CTC, patients receive a computed tomography (CT) scan which is an X-ray test that creates axial images of the body, and these images are reconstructed into three-dimensional computer images of the inside of the colon, mimicking the view obtained via OC. CTC has a number of potential advantages compared with conventional colonoscopy. It is a noninvasive technique, requires no sedation, and can be completed in a shorter period of time. Specifically, the procedure involves a technologist positioning the patient on the CT examination table, with the patient laying still on his back and/or stomach during the examination. A very small, flexible tube is passed just inside the patient's rectum to allow air to be gently pumped into the colon, distending it to eliminate folds or wrinkles that may obscure the physician's view. The table moves through a scanner, and once the scan is complete the tube will be removed. The entire CTC procedure is usually completed within approximately 10-15 minutes. The images from the CT scan are transferred to a computer, which creates a detailed two- and three-dimensional image of the interior of the colon, whereby a physician can evaluate this image for abnormalities. Since CTC is similar to an abdominal CT scan, it can also show abnormalities outside the colon which would otherwise be missed because OC only views the interior colonic surfaces. These extra-colonic findings occur in approximately 10-30% of patients, but only a portion of these abnormalities will be clinically important.

CTC also appears to be safer than colonoscopy. While colonic perforation, a potentially life-threatening event, occurs in 1:1000 patients who undergo OC, the risk of perforation with CTC is almost non-existent. CTC is a minimally invasive procedure that does not require anesthesia and hence the patient can drive himself home and engage in all activities after the procedure.

CTC is a newer procedure and not yet commonly performed. Like OC, CTC requires a full colon prep to avoid obscuring colonic abnormalities. Since CTC does not actually enter the colon to obtain images, it is solely a diagnostic test and offers no therapeutic options in the event that abnormalities are found. This lack of therapeutic options is a critical short-coming of CTC. Because of the difficulty and discomfort of performing colon prep for both CTC and OC, many CTC patients will be disappointed to learn after a positive CTC, that they must now schedule an OC to remove abnormalities, and perform a second colon prep prior to the scheduled OC. In as many as 20-30% of CTC patient screenings, polyps will be discovered and the second step of removal will need to be carried out with OC. These are the patients who must endure the burden of a second round of prep if initially screened by CTC. CTC suffers a further disadvantage that it is still considered an “investigational technique” by many health insurance companies and thus is not currently reimbursed for most patients. Recent (March 2008) endorsement of CTC as an appropriate colon cancer screening technique by professional radiology and GI societies and the American Cancer Society will likely result in reimbursement in the future.

Overall, however CTC's numerous benefits, namely its accuracy, convenience, minimal invasiveness, and absence of need for sedation/anesthesia, greatly appeal to patients. Its lower costs are favorable to the healthcare system. Because of these advantages, many experts forecast that CTC, despite its lack of therapeutic options, will eventually become the initial colon cancer screening modality of choice.

Magnetic Resonance Imaging (MRI) is a possible alternative to CTC. MRI uses a magnetic field rather than X-rays, and can often distinguish more accurately between healthy and diseased tissue. MRI gives better pictures of tumors located near bone than CT, does not use radiation as CT does, and provides pictures from various angles that enable doctors to construct a three-dimensional image of the tumor.

Gastroenterologists and other endoscopists (GIs) stand to lose economically if either CTC or MRI become the initial screening modality of choice, replacing OC. GIs typically derive a significant portion of their incomes from performing screening OC, a procedure which may be largely replaced by CTC/MRI. Further, many GIs have made financial investments in endoscopy centers and ambulatory surgery centers, investments that may suffer from the rise of image-based colon cancer screening.

GIs may attempt to offer CTC or MRI themselves, but face many hurdles. GIs typically have no formal clinical training interpreting medical imaging, and may have difficulty reading the images themselves. This is especially true with respect to the extracolonic findings, which will be present in as many as 30% of cases. These extracolonic findings present significant clinical imaging and malpractice liability issues for GIs. Furthermore, GIs would have difficulty managing complex imaging issues including acquiring and maintaining the necessary equipment/technology, recruiting and managing personnel, optimizing operations, and marketing their imaging services.

Because of the financial and scope-of-practice issues, there will likely be marketplace uncertainty over which medical specialty, GI or radiology, will control colon cancer screening.

Thus it would be greatly advantageous to create an integrated business process for colorectal cancer screening, sequentially deploying the most convenient and cost-effective modality, CTC, first, followed seamlessly by a same-day, same-prep OC for those patients for whom colon polyps are discovered. This novel, integrated colorectal cancer screening process would optimize the benefits of each of the separately deployed modalities by increasing patient convenience, safety, satisfaction, and cancer screening rates, while minimizing healthcare system costs.

### SUMMARY OF THE INVENTION

It is an object of the present invention to provide a colon screening process for deployment as a managed operation either licensed or sold to community GIs or other endoscopists who also own/manage endoscopy centers.

It is another object to provide a colorectal cancer screening system and method that integrates an imaging center as an intermediary between an endoscopy center and radiology services, the imaging center serving as a computed tomography colonography (CTC) or magnetic resonance imaging (MRI) screening and patient referral source to the endoscopy center.

Yet another object of the present invention is to define an operational/implementation process for the foregoing that ensures same-day patient flow, allowing optimal and customized use of technology for each patient, that is minimally invasive to patients, improves patient acceptance and satisfaction, and results in higher community colorectal cancer screening rates.

Another object of the present invention is to provide a colorectal cancer screening system and method that combines the benefits of CTC (or MRI) and OC, and which affords patients seamless same-day, same-prep service to undergo therapeutic intervention should an abnormality be found during CTC, and thus preventing the need for a second, uncomfortable colon prep in these patients.

Yet another object of the present invention is to provide a colorectal cancer screening system and method that affords cost-benefits to health insurers.

It is another object of the present invention a colorectal cancer screening system and method that safeguards GI's initial investment in endoscopy centers and helps maintain their income from colorectal cancer screening.

Yet another object of the present invention is to provide a colorectal cancer screening system and method that improves community cancer screening rates and improves insurers' Health Plan Employer Data and Information Set (HEDIS) Scores.

In accordance with the foregoing objects, the present invention is a colorectal cancer screening system and method that may be contractually deployed as a managed operation, either licensed or sold to community-based GI specialists or other endoscopists who also own endoscopy centers. The process includes co-locating or near-locating an imaging center with an (existing) endoscopy center, a workflow that integrates the two screening modalities (CTC/MRI and OC) and allows for the seamless, same-day, same-prep referral of patients with positive or indeterminate imaging findings into open slots in the co-located endoscopy center. This integrated process ensures the optimal use of technology for each patient (many patients will be shown to have a “clean colon” on CTC and will thus avoid the need for OC), but also ensures that each patient will have access to the definitive, therapeutic procedure (OC), if necessary, without the discomfort and inconvenience of scheduling for another day and having to perform a second colon prep. The co-located (or near-located) imaging center may be CTC or MRI, and in either case must be proximate to an existing endoscopy center to allow for the convenient flow of patients between the two sites. The imaging center must also have real-time access to onsite or offsite (teleradiology) radiology reading services in order to ensure rapid turn-around of results. The method generally comprises the steps of physically creating and contractually implementing the intermediary imaging center to serve as a CTC or MRI screening and patient referral source to the existing co-located endoscopy center, and the implementing a workflow for the foregoing that ensures same-day patient flow, allowing optimal and customized use of technology for each patient, that is minimally invasive to patients, improves patient acceptance and satisfaction, and results in higher community colorectal cancer screening rates.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram of the system 1.

FIG. 2 is a flow diagram illustrating the typical hub-and-spoke tele-radiology workflow of the present colorectal cancer screening system 1 and method, that ensures quality, timeliness, and cost-effectiveness of CTC reads.

FIG. 3 is a flowchart of the method 400 of the present invention.

### DETAILED DESCRIPTION OF THE PREFERRED EMBODIMENTS

The present invention is a colo-rectal cancer screening system 1 and method comprising 1) a newly-formed imaging center that is “co-located” (meaning in the same building or within a short travel distance, and preferably no more than three (3) miles) and integrated with 2) an endoscopy center and 3) onsite or offsite radiology services, and 4) a workflow that integrates the services of the endoscopy center, imaging center, and radiology services. The imaging center serves as a CTC or MRI screening and patient referral source to the endoscopy center using a defined workflow that ensures same-day, same-prep patient flow with optimal use of the technology for each patient.

The system provides optimal use of colon cancer screening services for patients allowing them to use the more comfortable and convenient CTC screening test, but also providing the opportunity for same-day, same-prep access to a therapeutic OC if polyps or other abnormalities are discovered on the CTC. The system is a very cost-effective way to screen large populations and is therefore cost-beneficial to health insurers and employers. Further the system is extremely beneficial to community GI specialists and other endoscopists, since it allows them to own and manage the entire colon cancer screening process in their community, and to preserve their investment in the endoscopy centers.

The system comprises a newly-formed imaging center that is integrated with a co-located (often pre-existing) endoscopy center, and served by onsite or offsite radiology reading services, with provider agreements in place that tie together the services of radiologists and GIs in a logistical workflow that deploys CTC or MRI in a more patient-friendly approach.

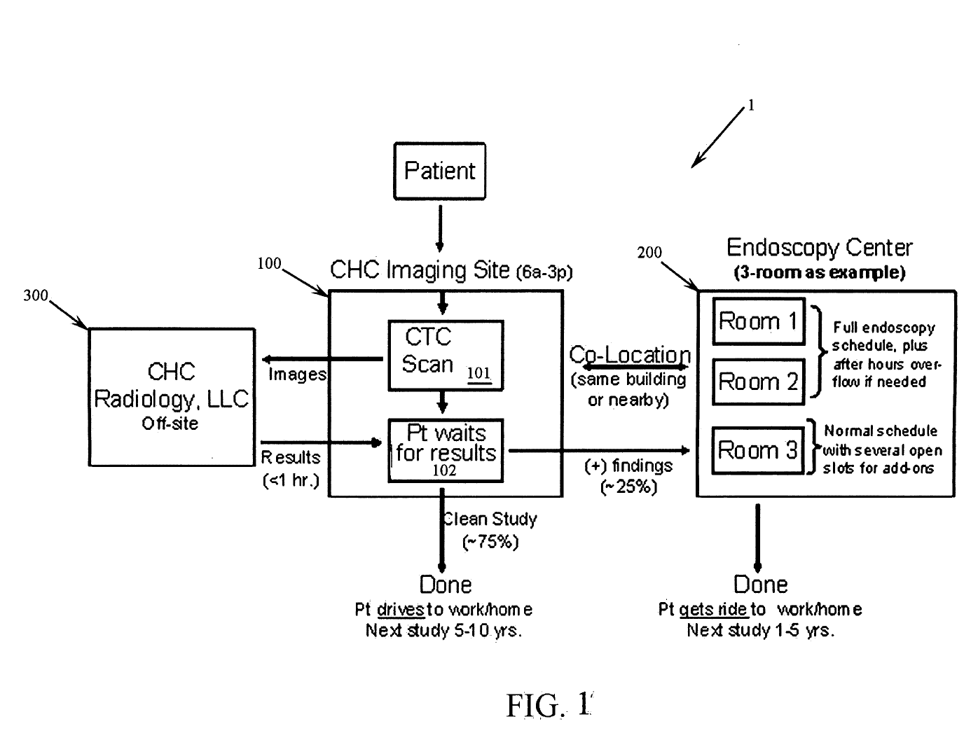

FIG. 1 is a block diagram of an exemplary system 1 that is based on the creation of a new CT-based imaging center 100 (co-located either in or at an existing endoscopy center 200 or proximate thereto). These two facilities 100, 200 make up the fundamental unit of the system (a single “Colon Health Center”). In addition, a radiology reading services center 300 serves each unit of the Colon Health Center (imaging center 100 and endoscopy center 200), and radiology reading services center 300 may be integral to or offsite and independent (but contractually obligated) to the CT-imaging center 100.

In operation, patients will be referred to the imaging center 100 either through Primary Care Physician referrals, referrals from other specialists, patient self-referral, or referral from owning GI group. They are directed to the imaging center 100 to undergo CTC at the site 100. CTC is a non-invasive examination and can be generally completed within 10-15 minutes. No intravenous (IV) contrast is required, and patients can return to their regular diet and activity within one hour of exam completion, if the reading reveals no abnormality. Thus, it is envisioned that the CHC imaging center 100 will screen as many as 25-30 patients per scanner in a single 8 hour day, and in this regard comprises one or more CT scanners 101 and patient waiting area 102. The CT scanner(s) 101 may be, for example, a Siemens™ SOMATOM® Definition which provides a non-invasive, fast, pain-free experience and exceptional image quality at half the radiation dose used by conventional CT scanners. A moveable examination table slides into and out of the CT scanner tunnel (gantry).

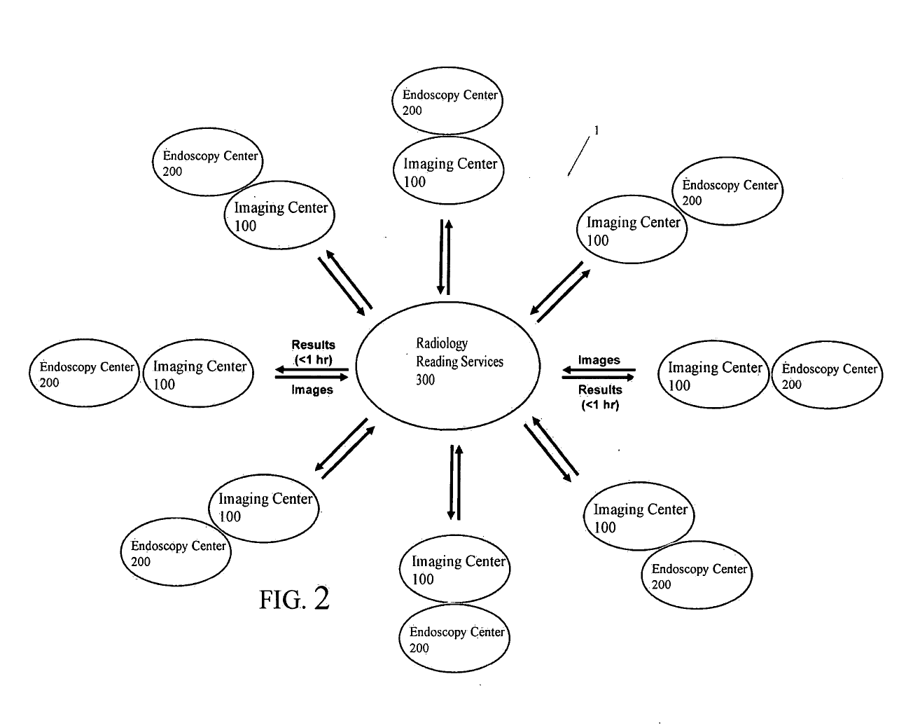

FIG. 2 is a flow diagram illustrating the leveraged centralized radiology reading system that services each unit Colon Health Center (an imaging center 100 and an endoscopy center 200). This centralized radiology reading service 300 is a key component of the overall system since it is difficult to obtain local, cost-effective radiology reading services that can also provide timely reading results. Therefore the present radiology reading services 300 are preferably provided via a centralized hub, which consists of employed or independently-contracted radiologists whose role is to provide expert and timely CTC reads for multiple endoscopy centers 200 and imaging centers 100, and to share the resources of the central radiology services 300 in a hub-and-spoke manner. Each imaging center 100 is affiliated with a corresponding endoscopy center 200, and with the onsite or offsite radiology reading services 300, with provider agreements in place that tie together the services of radiologists and GIs in a logistical workflow that deploys CTC or MRI in a more patient-friendly approach.

In accordance with the present invention, image readings are performed and reported within 60 minutes after image acquisition, and this requires close coordination and flexibility on the part of the radiology services 300. Radiology services 300 may be an onsite or (more typically) offsite function of the imaging center 100. In an offsite case, the CTC images will be immediately transmitted (electronically) to an off-site Radiology Services Center (RSC) 300 or, alternatively, the CTC images can be made web-accessible to the radiology services 300 for remote viewing. The interpreting physicians, typically radiologists who are employed or contracted to the radiology services 300, are contractually bound to the imaging center 100 to provide substantially real-time image analysis (“real-time” herein being defined as one hour or less). For this it is envisioned that a provider agreement will specify the turnaround time for the results within approximately one hour. Thus, when the images are transmitted to or remotely viewed at the Radiology services 300, a radiologist interprets them by analyzing the images on a computer, after which the radiologist will send a professional interpretation (preferably in the form of an electronic, signed report) back to the imaging center 100.

The medical personnel at the imaging center 100 report the results to the patient who has been waiting in the waiting area 102 during the one-hour period. If there are positive findings (typically 15-30% of cases) the patients are immediately sent to the endoscopy center 200 where they undergo an OC. Alternatively, if patients are found to have no abnormalities on CTC, which is true in as many as 70-85% of cases, then they are free to drive themselves home and resume all activities. It is an essential advantage of the present system that these patients who have no abnormalities are spared the higher safety risk and discomfort of OC by virtue of undergoing CTC as an initial step in the colon cancer screening process.

Most existing endoscopy centers incorporate an existing number of patient endoscopy rooms, typically 1-5 rooms, which are typically scheduled in advance for procedures. In accordance with the present system, adequate space and availability in the endoscopy center must be maintained in order to accommodate patients with positive CTC findings who will need same-day OC procedures. To ensure such access to the endoscopy center 200, available add-on space must be provided for these patients. For example, the schedule of one of these rooms would typically maintain space for “add-on” cases to accommodate same-day OC procedures for patients with positive CTC findings. Thus, in a three room example (as shown in FIG. 1), in Rooms 1 and 2, the GI physicians may attend to previously scheduled patients through much of the day. Room 3, in this example, may be filled with previously-scheduled procedures in the very early morning (7 am-9 am). Thereafter, however, the Room 3 schedule must provide add-on capability to accommodate new OC procedures necessitated by the same-day CTC results from the imaging center 100. Further in this example, after scheduled procedures are completed in Rooms 1 and 2, usually by mid-afternoon, these rooms would also be available to accommodate additional patients with positive CTC imaging findings as needed. Thus, the present system is calculated to integrate into an existing endoscopy center, based on the typical surplus capacity of the existing number of patient endoscopy rooms, without detracting from the existing workflow or detracting from advance-scheduled procedures. Specifically, an independent endoscopy center 200 provider agreement will specify that the endoscopy center 200 make a predetermined amount of space available for add-on patients, defined in terms of hours (or “slots”) per day. This ensures that the therapeutic options of OC are quickly and conveniently available to all patients who need them that same day, avoiding the need to schedule a second procedure and administer a second, uncomfortable colon prep at a later date. For example, of the 25-30 patients per scanner-day entering the imaging center 100, as many as 25% will require referral to the endoscopy center 200 for an OC procedure. Therefore, it can be anticipated that as many as 5-10 patients per scanner-day will need to be directed to the endoscopy center for therapeutic intervention with OC, and thus the need for open scheduling or add-on space in Room 3 beginning approximately mid-morning. Of course, there are various ways to contractually allocate space, including keeping a room open after noon, reserving one room per hour, etc. For present purposes, the endoscopy center 200 provider agreement may simply specify that the endoscopy center 200 make three hours per day available for add-on patients, and this provider agreement may be recast and/or scaled up as needed depending on the number of scanners at the imaging center 100. Note that if the radiology center 300 is integral to the CTC Imaging Center 100 and part of the same owner-entity, a provider agreement will be unnecessary.

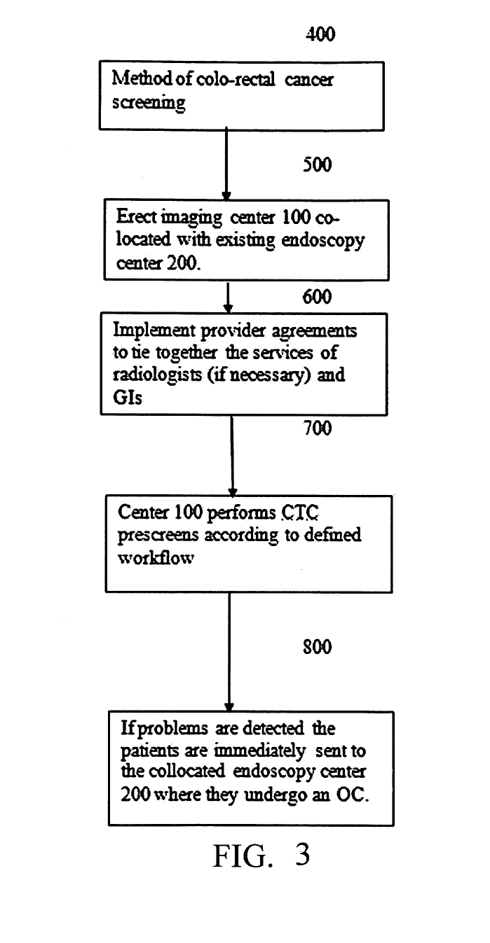

FIG. 3 is a flowchart of method 400 of the present invention, which generally comprises the following steps:

Step 500. Erect CTC imaging center 100 co-located (at or proximate to) an existing endoscopy center 200.

Step 600. Implement provider agreements to tie together the services of radiologists (if necessary) and GIs requiring substantially real-time interpretation by radiologists of CTC images.

Step 700. Center 100 performs CTC prescreens according to defined workflow.

Step 800. If there are positive findings, the patients are immediately sent to the co-located endoscopy center 200 where they undergo a same-day OC.

More specifically, at Step 500, a CTC imaging center 100 is created so that it is co-located or near-located with existing endoscopy center 200 inclusive of one or more CT scanners 101, patient waiting area 102, and appropriate medical personnel staffing. The center 100 may be located in the same building with the existing endoscopy center 200, or in a separate building proximate to the endoscopy center 200. This step also entails capital acquisitions (purchasing the CT scanner(s) and software and technology needed to transfer data (if necessary) to an offsite radiology services center 300; personnel recruitment (including technologists, off-site radiologists); site planning and any necessary building (including logistics of co-locating CT and OC services); obtaining any necessary regulatory approval for creating health center; entering contracts with health insurance companies or other payors for health care services rendered; marketing the health center; drafting policies and procedures of the center; education and training, marketing programs, managing lease of equipment/space, and beginning payor relations.

At step 600 the CTC imaging center effectuates provider agreements that tie together the services of radiologists 300 (if necessary) and GIs 200 to implement the defined workflow. The provider agreements with the radiology center 300 require turnaround time for imaging results of one hour or less, and those with the endoscopy center 200 require that space be made available of add-on patients. Note that the radiology center 300 may be integral to the CTC Imaging Center 100 and part of the same entity, and in this case a provider agreement will be unnecessary.

Following this is Step 700, wherein the CTC Center 100 performs CTC screening according to the workflow described above. The imaging center 100 submits the image readings immediately after image acquisition to the radiology services 300, obtains a reading from the radiology services within one hour, and then the medical personnel at the imaging center 100 report the results to the patient who has been waiting in the waiting area 102. If patients are found to have no abnormalities (which is true in as many as 70-85% of cases), then they are discharged and can drive themselves home and resume all activities.

At step 800, if there are positive findings, the patient is immediately directed and admitted to the endoscopy center 200 for OC, using available add-on space, and receives a therapeutic colonoscopy and polyp removal.

Note that the foregoing construct allows GI specialists to begin to capitalize on the growing CTC industry without cannibalizing their existing endoscopy practice. This is important to allow them to maintain their investments in their endoscopy centers. Indeed, the present business process may result in an increased case flow for GI's.

Health insurers or other payors find the system 1 and method 400 cost-effective and hence will support such. CTC is less costly than OC, and as an initial screening step, will save insurers money. Although an OC must be performed in addition to CTC in cases where abnormalities are found with the CTC, there is still an overall cost savings for the insurer since, in as many as 70-85% of the cases, only the less expensive CTC will be required.

Through the present system 1 and method 400, GI specialists will not have to surrender colon screening to radiologists, and yet radiologists will still be involved in colon screening and collect fees, salaries, or contractual allotments for these services. This minimally invasive system will increase patient satisfaction and allow more patients to be screened. As a result, the present system 1 and method 400 will improve overall community colorectal cancer screening rates, and will improve health insurers Health Plan Employer Data and Information Set (HEDIS) scores-a measure of the plan's effectiveness in promoting good healthcare in the community, (once CTC is included by the National Committee on Quality Assurance (NCQA) in its HEDIS measurement system).

Although the above example illustrates a new CT-based Colon Health Center (CHC) 100 co-located either at an existing endoscopy center 200 or proximate thereto, one skilled in the art will readily appreciate that all the same benefits can be derived through the use of magnetic resonance imaging (MRI) as an alternative to CT, without departing from the defined prescreen and patient referral workflow that ensures same-day patient flow with optimal same day service.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A colo-rectal cancer screening system comprising:
an imaging center for acquiring images of patients for colorectal cancer pre-screening;
radiology reading services in data communication with said imaging center for accessing said patient images via computer, viewing said patient images, interpreting said images, and generating a report of said interpretation, all within one hour of said imaging center acquiring said images;
an endoscopy center co-located with said imaging center for performing same-day optical colonoscopies on said patients when said report indicates polyps or colorectal cancer.

2. The colorectal cancer screening system according to claim 1, wherein said radiology services is contractually bound to view said patient images, interpret said images, and generate a report of said interpretation within one hour of said imaging center acquiring said images.

3. The colorectal cancer screening system according to claim 1, wherein said endoscopy center is contractually bound to perform same-day optical colonoscopies on said patients when said report indicates the presence of polyps or potential colorectal cancer.

4. The colorectal cancer screening system according to claim 1, wherein said imaging center comprises a computed tomography colonography (CTC) scanner for acquiring images of patients for colorectal cancer screening.

5. The colorectal cancer screening system according to claim 1, wherein said imaging center comprises a magnetic resonance imaging (MRI) scanner for acquiring images of patients for colorectal cancer screening.

6. A colorectal cancer screening method comprising the steps of:
erecting an imaging center at or near an existing endoscopy center;
implementing a provider agreement between said endoscopy and imaging centers requiring same-day treatment of patients referred to said endoscopy center by said imaging center;
performing screening colon imaging at said imaging center;
discharging patients if no problems are detected;
when problems are detected, immediately sending patients to the co-located endoscopy center to undergo a same-day OC.

7. The colorectal cancer screening method according to claim 6, further comprising a step of implementing a provider agreement between said imaging center and a radiology service for interpreting screening images within one hour of receipt.

8. The colorectal cancer screening method according to claim 7, wherein said step of performing screening colon imaging at said imaging center further comprises obtaining a screening image at said imaging center, making said image available to said radiology service, and procuring an interpretation of said image within one hour.

9. The colorectal cancer screening method according to claim according to claim 6, wherein said provider agreement requires a prescribed amount of endoscopy room availability per day.

10. The colorectal cancer screening method according to claim 10, wherein said imaging center comprises a magnetic resonance imaging (MRI) scanner for acquiring images of patients for colorectal cancer screening.

11. The colorectal cancer screening method according to claim 10, wherein said imaging center comprises a computed tomography colonography (CTC) scanner for acquiring images of patients for colorectal cancer screening.
